(19) United States
(12) Patent Application Publication
(10) Pub. No.: US 2021/0317018 A1
(43) Pub. Date: Oct. 14, 2021

(54) SYSTEMS AND METHODS FOR REMEDIATING AQUACULTURE SEDIMENT

(71) Applicants: Greg Wanger, Halifax (CA); Christopher Algar, Halifax (CA)

(72) Inventors: Greg Wanger, Halifax (CA); Christopher Algar, Halifax (CA)

(21) Appl. No.: 17/271,740

(22) PCT Filed: Aug. 30, 2019
(86) PCT No.: PCT/CA2019/051213

§ 371 Date: Feb. 26, 2021

Related U.S. Application Data
(60) Provisional application No. 62/724,861, filed on Aug. 30, 2018.

(51) Int. Cl. C02F 3/00; C02F 1/461; A01K 63/04

(52) U.S. Cl. CPC C02F 3/005; C02F 1/46109; C02F 2103/20; C02F 2001/46157; A01K 63/045

(57) ABSTRACT

A microbial electrochemical cell is described herein. The cell includes an anode electrode disposed in an anoxic environment below a water surface. The anode receives electrons from anaerobic decomposition of organic matter or other reduced compounds by microbes in sediment below the water surface. The cell also includes a cathode electrode disposed in an environment at a higher electrochemical potential than the anoxic environment. The cathode is electrically connected to the anode to receive the electrons from the anode. A reference electrode is disposed in the environment at the higher electrochemical potential than the anoxic environment. A potentiostat is electrically connected to each of the anode, the cathode and the reference electrode and is configured to receive electrons from the anode and control distribution of the electrons to the cathode based on a potential difference between the anode and the reference electrode. Methods of remediating aquaculture sediment are also described.

### CROSS-REFERENCE

This application claims the benefit of U.S. Provisional Patent Application No. 62/724,861, filed Aug. 30, 2018, and the entire contents of U.S. Provisional Patent Application No. 62/724,861 is hereby incorporated by reference.

### TECHNICAL FIELD

The embodiments disclosed herein relate to microbial electrochemical cells, and, in particular to microbial electrochemical cells for remediating aquaculture sediment.

### BACKGROUND

It has long been known that bioelectricity can be generated when microbial populations are connected with an electric circuit across a redox gradient. Devices using this phenomenon of bioconverting chemical energy to electrical energy through the actions of microorganisms are generally called microbial electrochemical cells (MECs).

In their simplest form, MECs can be created by placing a conducting material serving as an anode in a reducing environment, such as an anoxic sediment, and connecting the conducting material to a cathode in a more oxidizing regime such as an overlying oxygenated water column. This type of MEC is typically called a Microbial Fuel Cell (MFC). In devices such as these, rather than carry out anaerobic respiration, the microbial community that colonizes the anode will instead pass electrons to the anode through extracellular electron transport. These electrons travel along a wire connecting the anode to the cathode, generate an electric current and are used to oxidize O₂ to H₂O by the actions of aerobic microbes colonizing the cathode or a catalyst. The electricity produced by this process may be small, but these types of processes have been considered as methods of powering low-power oceanographic sensors or as a means of energy recovery in wastewater treatment.

Sediments underlying aquaculture, such as finfish aquaculture cages and shellfish or land based aquaculture tanks/ponds, generally receive elevated levels of organic matter input (e.g. from fish feces and residual fish food). The accumulation of organic material can provide anoxic conditions in the sediment below that can stimulate the production of hydrogen sulfide (H₂S), which is toxic to fish and benthic fauna. This accumulation of H₂S is subject to environmental regulation for aquaculture operations in some jurisdictions.

Current practices for lessening the risk of hydrogen sulfide accumulation include conservative stocking densities to avoid excess waste accumulating on the underlying sediment; the introduction of aeration to inhibit low dissolved oxygen levels in fish cages; and operating in high flow environments. Further, operators are generally required to introduce a lag time between growth cycles to allow underlying sediment to recover and naturally reduce hydrogen sulfide concentrations therein.

These current practices do not provide for efficient farming. Additionally, conservative stocking reduces yields from the farm, introducing aeration can be expensive, operating in high flow environments limits locations, and lag times between crops are inefficient.

Accordingly, there is a need for improved systems and methods of remediating aquaculture sediments and promoting the environmentally sustainable operation of fish farms by reducing sulfide levels below those mandated by regulations.

### SUMMARY

According to a broad aspect, a microbial electrochemical cell for remediating aquaculture sediment or a kit for assembling a microbial electrochemical cell for remediating aquaculture sediment is described herein. The microbial electrochemical cell includes an anode electrode configured to be disposed in an anoxic, or microaerophilic environment either above or below the sediment-water interface. The anode receives electrons from decomposition of organic matter or other reduced compounds produced by microbial respiration in sediments. The microbial electrochemical cell also includes a cathode electrode configured to be spaced apart from the anode and disposed in an environment at a higher electrochemical potential than the anoxic environment. The cathode electrode is electrically connected to the anode electrode to receive the electrons from the anode electrode. The microbial electrochemical cell also includes a reference electrode configured to be disposed in the environment at the higher electrochemical potential than the anoxic environment. The reference electrode has a stable electrode potential. The microbial electrochemical cell also includes a potentiostat configured to be electrically connected to each of the anode electrode, the cathode electrode and the reference electrode. The potentiostat is configured to receive the electrons from the anode electrode and control distribution of the electrons to the cathode electrode based on a potential difference between the anode electrode and the reference electrode.

According to another broad aspect, a microbial electrochemical cell for remediating aquaculture sediment is described herein. The microbial electrochemical cell includes an anode electrode disposed in an anoxic, or microaerophilic environment either above or below the sediment-water interface. The anode receives electrons from decomposition of organic matter or other reduced compounds produced by microbial respiration in sediments. The microbial electrochemical cell also includes a cathode electrode spaced apart from the anode and disposed in an environment at a higher electrochemical potential than the anoxic environment. The cathode electrode is electrically connected to the anode electrode to receive the electrons from the anode electrode. A reference electrode is disposed in the environment at the higher electrochemical potential than the anoxic environment. The reference electrode has a stable electrode potential. A potentiostat is electrically connected to each of the anode electrode, the cathode electrode and the reference electrode. The potentiostat is configured to receive the electrons from the anode electrode and control distribution of the electrons to the cathode electrode based on a potential difference between the anode electrode and the reference electrode.

In some aspects, the microbial electrochemical cell further includes an external power source configured to be electrically connected to the potentiostat, or a battery providing energy to the potentiostat for maintaining the potential difference between the anode electrode and the reference electrode.

In some aspects, the anode electrode is configured to be disposed in the aerobic water.

In some aspects, the anode electrode is configured to be disposed on top of the sediment below the surface of the water.

In some aspects, the anode electrode has an open configuration to provide for organisms to burrow into the sediment through apertures in the anode electrode.

In some aspects, the anode electrode is configured to be disposed below a surface of the sediment.

In some aspects, the anode electrode is a carbon fibre net.

In some aspects, the anode electrode has a square or circular shape.

In some aspects, the anode electrode has a three-dimensional shape.

In some aspects, the anode electrode oxidizes hydrogen sulfide provided by the anaerobic decomposition of organic matter by microbes in the sediment or the organic matter directly.

In some aspects, the reference electrode is configured to be disposed in the aerobic water.

In some aspects, the potentiostat is electrically coupled to each of the anode electrode, the cathode electrode and the reference electrode by an electrically conductive connector.

In some aspects, the electrically conductive connector is a wire and the wire is woven through or fastened to a portion of the anode electrode.

In some aspects, the microbial electrochemical cell is part of a filtration and water purification apparatus of a land-based aquaculture tank.

According to another broad aspect, a method of remediating aquaculture sediment is described herein. The method includes disposing an anode electrode in an anoxic environment below a surface of water, the anode receiving electrons from anaerobic decomposition of organic matter by microbes in the sediment. The method also includes disposing a cathode electrode spaced apart from the anode in an aerobic environment below the surface of the water, the cathode electrode electrically connected to the anode electrode to receive the electrons from the anode electrode. The method also includes disposing a reference electrode in the anoxic environment below the surface of the water, the reference electrode having a stable electrode potential.

In some aspects, the method also includes the option of electrically connecting a potentiostat (e.g. a device for setting the electrical potential of the electrodes vs. a reference electrode) to each of the anode electrode, the cathode electrode and the reference electrode. The potentiostat may be configured to receive the electrons from the anode electrode adjusting the rate to maintain the electrode potential with respect to a reference electrode. The method also includes controlling distribution of the electrons to the cathode electrode based on a potential difference between the anode electrode and the reference electrode.

In some aspects, the aquaculture sediment is below a finfish aquaculture cage.

In some aspects, the aquaculture sediment is below a shellfish aquaculture cage.

In some aspects, the aquaculture operation remediated is land based.

In some aspects, the aquaculture operation remediated is open water; fresh, brackish and salt water.

In some aspects, the anode electrode oxidizes hydrogen sulfide provided by the anaerobic decomposition of organic matter by microbes in the sediment.

In some aspects, the anode electrode oxidizes organic matter by microbes in the sediment.

According to another broad aspect, use of a microbial electrochemical cell for remediating aquaculture sediment is described herein. The microbial electrochemical cell includes an anode electrode configured to be disposed in an anoxic, or microaerophilic environment either above or below the sediment-water interface. The anode receives electrons from decomposition of organic matter or other reduced compounds produced by microbial respiration in sediments. The microbial electrochemical cell also includes a cathode electrode configured to be spaced apart from the anode and disposed in an environment at a higher electrochemical potential than the anoxic environment. The cathode electrode is electrically connected to the anode electrode to receive the electrons from the anode electrode. The microbial electrochemical cell also includes a reference electrode configured to be disposed in the environment at the higher electrochemical potential than the anoxic environment. The reference electrode has a stable electrode potential. The microbial electrochemical cell also includes a potentiostat configured to be electrically connected to each of the anode electrode, the cathode electrode and the reference electrode. The potentiostat is configured to receive the electrons from the anode electrode and control distribution of the electrons to the cathode electrode based on a potential difference between the anode electrode and the reference electrode.

Other aspects and features will become apparent, to those ordinarily skilled in the art, upon review of the following description of some exemplary embodiments.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a perspective view of an aquaculture remediation system having a microbial electrochemical cell, according to one embodiment;

FIG. 2A is a graph showing open circuit voltage versus time for a 21-day microbial electrochemical cell experiment using the microbial electrochemical cell of FIG. 1;

FIG. 2B is a graph showing power density curves for each day of the 21-day microbial electrochemical cell experiment of FIG. 2A;

FIG. 2C is a graph showing cell voltage versus current on the final day of the 21-day microbial electrochemical cell experiment of FIG. 2A;

FIG. 2D is a graph showing voltage over 12 hours of operation during the 21-day microbial electrochemical cell experiment of FIG. 2A;

FIG. 3A is a graph showing model simulation results of sulfide flux across the sediment-water interface of the microbial electrochemical cell of FIG. 1A;

FIG. 3B is a graph showing model simulation results of average sulfide concentrations in the top 2 cm of sediment consistent with the Nova Scotia EMP. Red lines represent the control simulation without the operation of the MFC and Blue lines represent the simulation with an operation microbial electrochemical cell;

FIG. 4 is a graph showing power curves for cell 1, 2 and 3 taken on day 0, 7, 27, 46 and 98;

FIG. 5 shows profiles of dissolved oxygen over the course of the 98-day experiment (Day 0, 46, 98);

FIG. 6 shows profiles of pH over the course of the 98-day experiment (Day 0, 46, 98);

FIGS. 7A and B are graphs showing example of oxygen, pH and total sulfide profiles for a tank containing an active microbial fuel cell (Cell 3, FIG. 7B) and a control tank (Control, FIG. 7A) at the end of the experiment (day 98);

FIG. 8 shows profiles of total sulfide over the course of the 98-day experiment (Day 0, 46, 98);

FIG. 9 is a graph showing final sulfide profiles from each tank taken on day 98 of the experiment;

FIG. 10 is a graph showing box plots which show variability in total sulfide content at the end of the experiment (day 98) within and between replicates of each condition. Homogenous subsets identified by the Tukey test are grouped by color; and

FIG. 11 shows a schematic diagram of main components of a sediment microbial fuel cell (SMFC) configuration, according to one embodiment, and the probable reactions taking place at each electrode.

The skilled person in the art will understand that the drawings, further described below, are for illustration purposes only. The drawings are not intended to limit the scope of the applicant's teachings in any way. In addition, it will be appreciated that for simplicity and clarity of illustration, elements shown in the figures have not necessarily been drawn to scale. For example, the dimensions of some of the elements may be exaggerated relative to other elements for clarity. Further aspects and features of the example embodiments described herein will appear from the following description taken together with the accompanying drawings.

### DETAILED DESCRIPTION

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Furthermore, it is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

It will also be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the result is not significantly changed. These terms of degree should be construed as including a deviation of the modified term, such as 1%, 2%, 5%, or 10%, for example, if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

In spite of the technologies that have been developed, there remains a need in the field for improvements in the systems and methods for remediating aquaculture sediment. Herein, the term aquaculture refers to the farming of fish, crustaceans, mussels, aquatic plants, algae, and other organisms. Aquaculture involves cultivating freshwater and saltwater populations under controlled conditions. Herein, the term aquaculture includes the term mariculture, which can refer to a specialized branch of aquaculture involving the cultivation of marine organisms for food and other products in the open ocean, an enclosed section of the ocean, or in tanks, ponds or raceways which are filled with fresh or seawater. An example of the latter is the farming of fish, including finfish and shellfish like prawns, or oysters and seaweed in ponds. Accordingly, the term aquaculture sediment refers to matter that settles to the bottom of the liquid in the aquaculture environment (e.g. soil, unconsumed food, feces, etc.).

Herein, the term “electrochemical cell” will be used to refer to devices that can be used to either generate electrical current from a chemical reaction (e.g. galvantic cell), or use an electrical current to drive a chemical reaction forward (e.g. electrolytic cell).

Herein, the term “fuel cell” will be used to refer to electricity generating electrochemical cell where the substrates for the chemical reaction are continuously supplied. A classic example is a hydrogen fuel cell whereby a flow of hydrogen gas reacts with oxygen supplied by a flow air.

Herein, the term “microbial electrochemical cell” (MEC) will be used to refer to an electrochemical cell in which the source of electrons for the electric circuit is supplied by the metabolism of a microbial community colonizing of the electrode surface. If the anode of the MEC is placed in an anoxic marine sediment, and the cathode in the overlying oxygenated water column, the MEC can be referred to as a Sediment Microbial Electrochemical Cell (SMEC).

Herein the tern “microbial fuel cell” (MFC) will be used to refer to a MEC that is used for power generation.

Herein the tern “poised potential microbial electrochemical cell” (PMEC) will be used to describe a MEC when the anode is a working electrode held at a fixed potential relative to a reference electrode.

Generally, MECs for remediating aquaculture sediment are described herein. The MECs may be operated as fuel cells for producing energy or may be operated as electrochemical cells where energy may be added to the cells (e.g. by a battery, mains power supply, or renewable source). The MECs may be used to remediate aquaculture sediment impacted by low, medium, or high levels of organic matter loading. Organic loading can be due to a number of different factors, including but not limited to feces from the fish in the aquaculture environment, unconsumed food, or naturally occurring organic matter deposition that collects in the underlying sediments.

In some embodiments, the MECs described herein use naturally occurring resident microbial populations in the aquaculture sediment to accelerate the decomposition of fish farm waste, for example. In some examples, the microbial populations can create an electrochemical barrier that inhibits the accumulation of chemicals that may be toxic to aquatic animals, particularly the benthic infauna living in the sediments (a key indicator of ecosystem health), as well as the aquatic animals forming the crop of the aquaculture environment. For instance, in some examples the microbial populations can create an electrochemical barrier that inhibits the accumulation of hydrogen sulfide in and around the aquaculture sediment. The source of hydrogen sulfide may be the anaerobic decomposition of organic matter by sulfate reducing microbes living in the sediment.

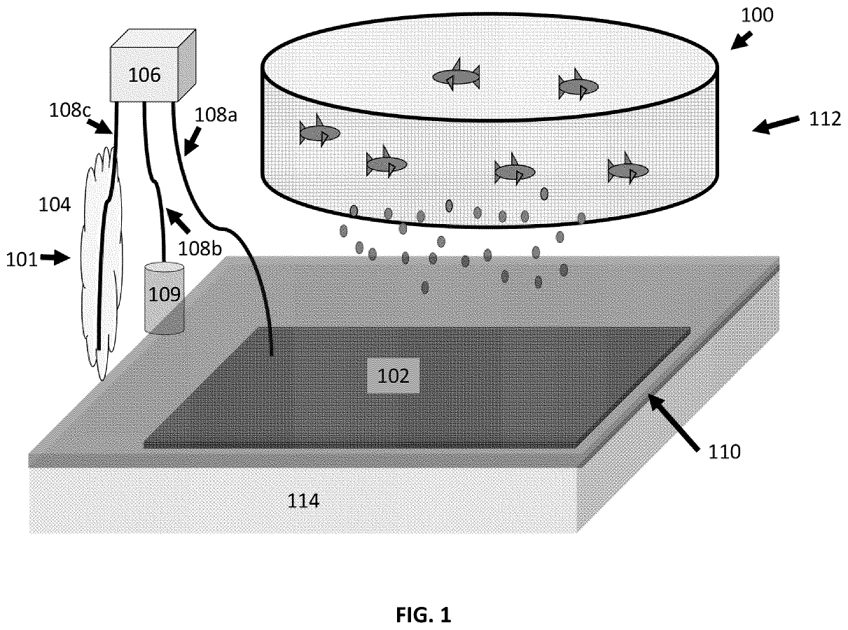

Referring to FIG. 1, illustrated therein is an aquaculture remediation system 100 including a microbial electrochemical cell 101. Microbial electrochemical cell 101 includes an anode or working electrode 102, a cathode or counter electrode 104, a potentiostat 106 and a reference electrode 109. An electrically conductive connector 108 connects each of the anode electrode 102, the cathode electrode 104 and the reference electrode 109 to the potentiostat 106.

In the example embodiment shown in FIG. 1, the aquaculture remediation system 100 is deployed at a water/sediment interface at a bottom surface 110 below a body of water 112. Bottom surface 110 defines a boundary between sediment 114 and the body of water 112. Body of water 112 is therefore bounded by a surface of water (not shown) and bottom surface 110.

Anode electrode 102 is disposed in a reducing environment, such as an anoxic environment, of the system 100 for accepting electrons generated by bacteria and/or microorganisms living in or near the sediment 114. In some embodiments, microbial activity is dependent on the anode's redox potential.

Anode electrode 102 can be disposed on or below bottom surface 110 forming the water/sediment interface of system 100. For instance, in some embodiments, anode electrode 102 is disposed on or above the bottom surface 110. In other embodiments, anode electrode 102 is disposed below the bottom surface 110. In yet other embodiments, the anode electrode 102 is initially disposed on or above the bottom surface 110 and over time be buried by the accumulation of organic matter and inorganic sediment including but not limited to unconsumed food and feces from above.

Anode electrode 102 can be any conducting material that can receive electrons from the colonizing anaerobic microbes of the reducing environment. For instance, anode electrode 102 can be made but not limited carbon, or graphite, stainless steel, or titanium. In some embodiments, anode electrode 102 may comprise a carbon cloth that makes direct contact with the aquaculture sediment 104.

One consideration in the design of anode electrode 102 is preserving sediment connectivity (e.g. anode electrode 102 remaining in the anoxic environment of system 100) and not inhibiting movement of burrowing and/or tube dwelling organisms in the body of water 112. Burrowing organisms can mix sediment particles deeper into the sediment 114 and tube dwelling organisms can irrigate existing burrows, which can provide for oxygen rich water adjacent to the sediment to infiltrate the sediment and accelerate reoxidation of the reduced byproducts of respiration.

Accordingly, in some embodiments, anode electrode 102 may have an open configuration. For instance, anode electrode 102 may be a carbon fibre net having apertures therein for providing the aforementioned infauna access to oxygenated water adjacent to the sediment. In other embodiments, anode electrode 102 may include carbon fibre brushes surrounding a central carbon fibre net. These carbon fibre brushes may increase a surface area of the anode electrode 102 to catalyze the anodic reaction.

Anode electrode 102 may be configured to be various sizes and/or shapes. For instance, anode electrode 102 may have a rectangular shape of about 10 cm by about 5 cm, or, in other embodiments, may have a circular shape with a radius of about 10 m. In some embodiments, anode electrode 102 may have a low internal resistance. In other embodiments, more than one anode electrode 102 can be provided and configured to operate concurrently.

Anode electrode 102 is electrically connected to the potentiostat 106 by a connector such as connector 108a shown in FIG. 1. Connector 108a can be any electrically conductive material. For instance, connector 108a may be but is not limited to a titanium wire. In some embodiments, connector 108a may be woven through the carbon mesh of the anode electrode 102. In some embodiments, connector 108a can be fixedly connected to anode electrode 102. For instance, connector 108a can be fixedly connected to anode electrode 102 mechanically or by glue or conductive epoxy.

Cathode electrode 104 is disposed below a surface of the water or at the air-water interface and spaced apart from anode electrode 102 in an aerobic environment. Cathode electrode 104 can be any conducting material such as but not limited to a platinum wire, a graphite wire, a carbon mesh or the like. Generally, a cathode electrode 104 has a more positive potential than anode electrode 102.

Cathode electrode 104 is electrically connected to the potentiostat 106 by a connector such as connector 108c shown in FIG. 1. Connector 108c can be any electrically conductive material. For instance, connector 108c may be a titanium wire. In some embodiments, connector 108c may be woven through the carbon mesh of cathode electrode 104. In some embodiments, connector 108c can be fixedly connected to cathode electrode 104. For instance, connector 108c can be fixedly connected to cathode electrode 104 by glue.

In the embodiment shown in FIG. 1 where the system 100 comprises three electrodes (i.e. anode electrode 102, cathode electrode 104 and reference electrode 109), cathode electrode 104 can be referred to as an auxiliary electrode or a counter electrode and anode electrode 102 can be referred to as a working electrode. In this embodiment, the potential of cathode 104 is generally not measured but rather is adjusted (e.g. by adjusting the potentiostat 106) to balance the reaction occurring at anode electrode 102. This configuration provides for the potential of anode electrode 102 to be measured against reference electrode 109 without compromising the stability of the reference electrode 109 by passing current over it.

System 100 also includes a reference electrode 109. Reference electrode 109 is an electrode that has a stable and well-known electrode potential. The high stability of the electrode potential is typically reached by using a redox system with constant (e.g. buffered or saturated) concentrations of each participant of the redox reaction.

Reference electrode 109 is electrically connected to the potentiostat 106 by a connector such as connector 108b shown in FIG. 1. Connector 108b can be any electrically conductive material. For instance, connector 108b may be a titanium wire.

In some embodiments, reference electrode 109 can be an Ag/AgCl reference electrode and be placed in the anoxic environment of system 100, such as but not limited to on or adjacent to bottom surface 110 adjacent to the anode electrode 102.

Potentiostat 106 is generally a hardware device that provides for the potential difference across cell 101 to be held constant at a specific voltage. As stated above, in MECs the reduction reaction at the cathode is generally the limiting factor in current flow. By introducing potentiostat 106 with a fixed (and configurable) potential into system 100, the reduction reaction at cathode electrode 104 is not the limiting factor in current flow, thereby lowering internal resistance in the cell 101 and accelerating the rate of reaction (e.g. sulfide oxidation rate) at anode electrode 102. Potentiostat 106 can therefore control the potential of cathode electrode 104 against the anode electrode 102 so that the potential difference between the anode electrode 102 and the reference electrode 109 is well defined, and specifically corresponds to a value specified by the user.

Potentiostat 106 is generally spaced from the anode electrode 102 and the reference electrode 109 and disposed adjacent to the cathode electrode 104 in an aerobic environment of system 100, as shown in FIG. 1.

In some embodiments, potentiostat 106 may be connected to a computer (e.g. a PC computer) or connected to the internet (not shown) equipped with software that provides for real-time monitoring of the current produced at the anode electrode 102.

In some embodiments, cell 101 can operate as a microbial fuel cell and produce energy from the decomposition of matter in the sediment 114. In other embodiments, cell 101 operates as an electrochemical cell. In some embodiments, cell 101 requires energy for the decomposition of matter in the sediment 114. In some embodiments, holding the potential difference across cell 101 constant may require input of electrical energy. Accordingly, in some embodiments, system 101 may further comprise an energy source (not shown) such as but not limited to a battery.

In use, the cell 100 includes naturally occurring resident microbial populations living in the sediment 110. The anaerobic decomposition of organic matter by sulfate reducing microbes living in the sediment generates hydrogen sulfide in the sediment 114. Organic matter and hydrogen sulfide is oxidized at the anode electrode 102 to generate electrons (e−) that flow from the anode electrode 102 towards the cathode electrode 104 through conductive connector 108a, into the potentiostat 106 and into connector 108c, as shown in FIG. 1. The protons (H+) permeate the body of water 112 and react with the electrons (e−) at the cathode electrode 104, thereby generating water (H₂O).

### EXAMPLES

In one example embodiment, an experiment using a laboratory scale cell was conducted, the setup and results of which are provided below. The aim of the experiment was to estimate the rate of carbon remineralization that could be expected. The results of this experiment were then used in a reactive-transport model describing carbon and nutrient cycling in sediment beneath fish-cages to assess benefits that could be achieved with such a system.

In one example embodiment, muddy sediments (e.g. 15-20% clay, 75-80% silt) with high organic matter content (5-6%) were collected from the Northwest Arm of Halifax Harbour, NS (location: 44 37′45 N 63 35′21 W) in 15 m of water depth using a KC Denmark multicorer. The top 60 cm of sediment was collected in four 95 mm ID core polycarbonate core barrels. These samples were transported back to the laboratory and the top 20 cm of sediment was taken from each core, sieved, homogenized and used for the microbial electrochemical cell. Homogenized sediment was placed in a 50×50×50 cm aquarium tank to a depth of 7.5 cm. Two 10 cm×5 cm carbon fabric anodes were placed on the sediment surface, and attached to each was a titanium wire, which was woven through the fabric and glued in place with non-toxic aquarium cement. The anodes were buried with an additional 2.5 cm of sediment. Seawater was slowly added so as not to disturb the sediment surface to a water depth of 18 cm. The titanium wires were connected to carbon fabric cathodes (10 cm×30 cm) placed in the overlying water column. As with the anodes, the titanium wire was woven into the fabric and glued in place. The first cathode-anode pair was connected to an external circuit with a 560 Ohm resistor. The other anode-cathode pair served as a control and was left as an open circuit. The temperature of the water and sediment was held constant at 21.5° C. and the MFC was operated for a period of 21 days.

The open circuit voltage (OCV) for both the cell and the control circuit were monitored daily throughout the experiment. Polarization and power density curves were constructed by measuring the voltage drop as a function of the external load. These measurements were made using a resistance ladder composed of 10,000, 8200, 5600, 3900, 2200, 1000, 560, 390, 220 and 100 ohm resistors. For each measurement, the wires from the anode and cathode were connected with alligator clips to each side of the resistor and a voltage meter was connected across it. After the voltage had stabilized, usually several minutes, the voltage was recorded. Finally, to assess the stability and continuous current output, the voltage was monitored using a do-it-yourself Arduino based voltage amplifier and logger.

Results

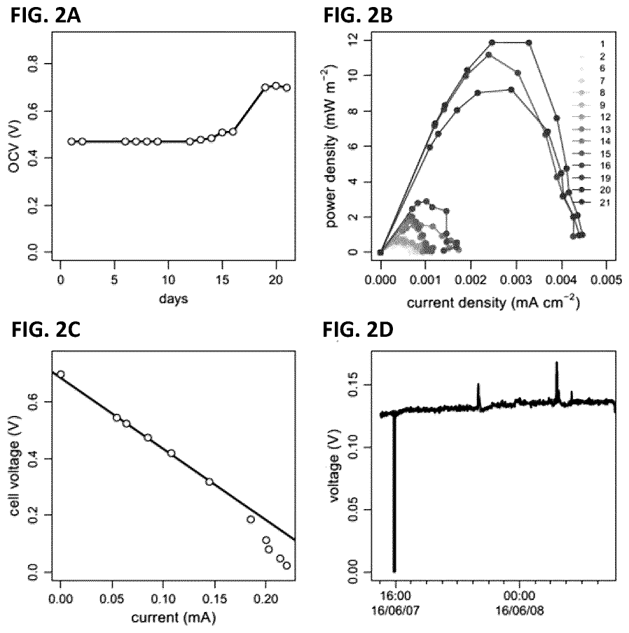

During the first 12 days of the experiment the cell open current voltage was relatively constant at 0.45 V before rising to 0.70 V between days 16 to 19 and then remaining steady for the final three days (see FIG. 2A). In contrast, the open circuit control had an OCV of around 0.20 mV (data not shown). This suggests that, although there was somewhat of an immediate response compared to the open circuit, it took over two weeks for the microbial community to fully establish. During this time a white precipitate began to accumulate around the anode and the titanium wire buried in the sediment, but was absent in the control. Based at least in part of the appearance, this precipitate is likely amorphous elemental sulfur formed from the oxidation of H₂S to S°, which is a common feature of suboxic environments such as salt marshes and hydrothermal vents where sulfide oxidizers are active. This suggests that sulfide oxidation is likely a key process involved in the transfer of electrons to the anode. One potential source of electrons for current generation was the oxidation of sulfide (HS⁻) or sulfide based minerals (FeS or FeS₂) according to the following three half reactions,

HS⁻→S⁰+2e⁻+H⁺

FcS→Fc²⁺S⁰+2e⁻

FeS₂→Fe²⁺+2S°+2e⁻

with the source of sulfide being the anaerobic decomposition of organic matter by sulfate reducing microbes living in the sediments surrounding the biofilm.

Two common matrices for evaluating the performance of cells are the power density and internal resistance of the cell. The power density per unit area of anode can be calculated from the voltage drop across the external load according to,

$${P}_{An} = \frac{{E}_{cell}^{2}}{{A}_{An} {R}_{ext}}$$

where P_{An} is the power per unit area of the anode, E_{cell} is the voltage across the external load, A_{An} is the area of the anode, and Rₑₓₜ is the external load. Power curves, throughout the duration of the experiment are shown in FIG. 2B. Like the OCV, they peak during the final three days once the microbial community has been fully established. The maximum power, obtained on day 20, was 12 mW m⁻² at a current density of 0.003 mW m⁻².

The internal resistance (Rᵢₙₜ) is the slope of the linear region of a current vs voltage curve. It is the sum of Ohmic losses associated with the flow of electrons through the electrodes and electrical connections, as well as resistance to the flow of ions back through the sediment toward the anode. For day 20 this was found to be 2500 (see FIG. 2C). The steep increase in slope at high currents is mostly likely due to transport limitation associated with either diffusion of the substrates to the biofilm or the uptake kinetics of these substrates by the microbes.

For many MEC applications, energy generation is the main goal, making power density a key parameter of evaluating the MEC performance. When the goal of the MEC, as in this case, is the oxidation organic matter and/or sulfide, power density is not a parameter that needs to be optimized. Instead, the MEC may be run with or without an external load to maximizes the current flow through the circuit. Since the original source of each electron flowing through the circuit is from the oxidation of organic matter, though likely with sulfide as an intermediate, the current density can be expressed as a carbon mineralization rate,

$${R}_{remin} = \frac{{I}_{A}}{4 F}$$

where I_{A} is the current density per unit area of the anode, F is Faraday's constant, and 4 is the moles of electrons required to oxidize 1 mole of organic matter to CO₂. This provides for the evaluation of cell performance in an environmental context. FIG. 2D shows the sustained current observed over 8 hours of operation near the end of the experiment after the cell was operating at full capacity. This shows that with the exception of a few spikes, that may be attributed to electrical interference, the cell voltage remained fairly steady at 0.13±0.01 V. This converts to a carbon oxidation rate of 380±30 μmol C cm⁻² y⁻¹. This is comparable to per area carbon remineralization rates observed in marine sediments. Depth integrated remineralization rates for marine sediments vary from <10 μmol C cm⁻² y⁻¹ in the deep ocean to greater then 1000 μmol C cm⁻² y⁻¹ in productive coastal regions. While carbon oxidation rates have not been estimated for the North West Arm, the yearly average sediment carbon flux at nearby Bedford Basin was measured to be 670 μmol C cm-2 y-1 while this can not be directly compared to the NW Arm since hydrographic conditions are quite different; Bedford Basin is a 70 m deep basin with reduced circulation, while the NW Arm is only 15 m deep with more vigorous mixing, it likely provides an order of magnitude estimate and suggests the MFC is capable of remineralizing a substantial portion of the annual organic matter loading rate.

Reactive Transport Modelling

Results from the experiment were used in combination with a sediment reactive-transport model to assess the potential of a cell such as described above to mitigate the buildup of sulfide beneath fish cages. For this, a numerical model that captures sediment carbon, oxygen, and sulfur dynamics may be used. Such models comprise a system of partial differential equations describing the transport and reactions influencing both solid (Cₛ) and dissolved (Cₚ) chemical species. The general form of these diagenetic equations are:

$$\frac{\partial {C}_{p}}{\partial t} = \frac{1}{ϕ} \frac{\partial }{\partial x} ( ϕ {D}_{p}^{′} \frac{\partial {C}_{p}}{\partial x} - ϕ u {C}_{p} ) + \sum {R}_{p} \\ \frac{\partial {C}_{s}}{\partial t} = \frac{1}{( 1 - ϕ )} ( ( 1 - ϕ ) {D}_{b} \frac{\partial {C}_{s}}{\partial x} - ( 1 - ϕ ) υ {C}_{s} ) + \sum {R}_{s}$$

where t is time and x the distance below the sediment water interface. D′ is the porosity corrected diffusion coefficient for Cₚ, D_{b} is the bioturbation coefficient which describes the mixing of sediment grains by the movements of animals, and u and v are the burial velocities of porewater and solids respectively. Finally, ΣRₚ are all the reactions involving Cₚ per unit volume of porewater and ΣRₛ the reactions involving Cₛ per unit volume of solids.

To incorporate the influence of the microbial cell, one can use the internal resistance, Rᵢₙₜ, calculated from FIG. 2C and a typical sediment potential difference of 0.75 V. From this, the total current density generated would be 0.006 mA m⁻², which converts to 2000 μmol e-cm⁻² y⁻¹ removed from the sediments. Assuming the source of these electrons is the oxidation organic matter to CO₂ or sulfide to elemental sulfur, this corresponds to a sulfide sink of 1000 μmol cm⁻² y⁻¹. One can then assume that these electrons are sourced from a 3 cm thick region of sediment surrounding the anode. The oxidation of sulfide by the cell is then modelled using a Gaussian function centered at a=1.5 cm depth and with a depth integrated area equal to the total current density,

$${R}_{MFC} = \frac{1}{2} \frac{{I}_{A}}{c \sqrt{2 π}} {e}^{- \frac{{( x - a )}^{2}}{2 {c}^{2}}}$$

where I_{A} is the current density, and c describes the width of the curve and is set to 0.75 cm.

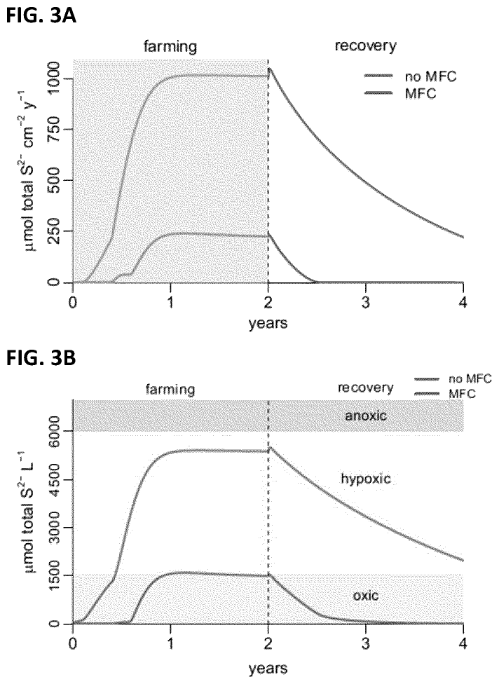

To understand the influence of the cell on sediment geochemistry during an aquaculture operation, two model simulations were conducted: a control simulation without the cell and one including the cell. Each simulation consisted of a two-year fish rearing cycling with elevated organic matter fluxes to the sediments, and a two year recovery period. The results of these simulations are shown in FIGS. 3A and 3B and indicate that the cell creates a protective barrier, preventing the flux of sulfide out of the sediments. FIG. 3A shows the sulfide flux for the control and cell simulations. During the control simulation sulfide fluxes reach 1000 μmol C cm⁻² y⁻¹. On the other hand the maximum sulfide flux in the cell simulation was only 25% of the control (250 μmol C cm⁻² y⁻¹), and dropped to essentially 0 within 6 months of recovery. To further quantify the effect of the cell, the simulations were compared to Nova Scotia, Canada's Environmental Monitoring Program (EMP). Nova Scotia, along with many other jurisdictions, use free sulfide concentrations as an indicator of the state of the benthic environment. In the Nova Scotia EMP, the average sulfide concentration in the top 2 cm of sediment is used to categorize the oxic state of the sediment, average concentrations of less then 1500 μmoles L⁻¹ are considered oxic and minimally impacted, sediments between 1500 and 6000 moles μmoles L⁻¹ are labeled hypoxic and >6000 moles μmoles L⁻¹ anoxic. Sites in the hypoxic or anoxic classifications require mitigation that can range from increased monitoring, early harvesting, fallowing, or the cessation of farming. FIG. 3B shows that the control simulation predicts high sulfide concentrations (5500 μmoles L⁻¹) in the upper region of the hypoxic classification and nearing anoxic, such sediment would be considered to be heavily impacted by aquaculture. The cell simulation in contrast, remained within the oxic classification during the entire two year fish rearing period and return to background levels within only 1 year of fallowing. The control simulations still have sulfide concentrations in the hypoxic classification after the two year fallowing period. So while, according to the Nova Scotia EMP, it may be difficult to continue aquaculture under the conditions of our control simulations, the addition of an electrochemical cell to the sediments beneath the cage may provide for the site to be farmed continuously with a fallowing period of only 1 year. This modelling exercise while idealized, clearly demonstrates the potential of microbial cells as an effective remediation technique for sediments subjected to increased organic matter loading.

### Examples

In one example, ten sediment cores (9.5 cm ID×50 cm) of organic rich, fine grained sediment (56% silt, 31% sand, 13% clay) were collected from the Northwest Arm in Halifax, Nova Scotia (44.631274, −63.596019) using a KC Denmark multi-corer. The sediment collected was combined and homogenized by mixing, before 8 L of sediment was distributed at the bottom of four 20.8 L aquarium tanks (40.6 cm×20.5 cm×25 cm). The sediment was allowed to settled over night before the anodes were placed in their respective tanks and buried with 2 L of sediment. The sediment surface was levelled ‘by eye’ before 8.5 L of seawater was carefully siphoned into each tank so as not to disturb the sediment surface while creating a region of overlying water. The experiment ran from August 10^{th} (day 1) to November 15^{th} (day 98), 2018 and the overlying water was bubbled to maintain oxygenated conditions throughout.

A different condition was assigned to each of the four tanks, two types of controls and two types of active SMFCs. Three of the tanks contained fuel cell components; an anode, cathode and reference electrode. The electric circuit which connected the anode to the cathode was disconnected in the first cell, Cell 1, to create an open circuit or inactive SMFC control condition. Cell 2 was set up as a regular active SMFC with an electric circuit connecting the anode, cathode and reference electrodes. A Gamry Reference 600+ Potentiostat was connected to Cell 3 in in order set a fixed potential on the anode while the cell ran as an active SMFC. The last tank contained no fuel cell components, serving as a Control condition. Due to difficulties in maintaining a fixed potential on Cell 3, on day 14 this approach was abandoned and Cell 3 was run as a regular active SMFC and treated as a replicate of Cell 2.

For each anode, five rows of pure titanium wire were woven length wise 2.5 cm apart into a 35×18 cm heat treated carbon fiber sheet. The carbon fiber was heat treated to burn off a pre-existing coating and to increase surface area. The titanium wires were joined and coated in liquid electrical tape. The titanium wire attached to the anode extended from the sediment through overlying water to a connection on a breadboard external to the tank.

For each cathode, pure titanium wires were woven width wise 5 cm apart into a 29×41 cm heat treated carbon fiber sheet. The titanium wires were joined and coated in liquid electrical tape. The carbon fiber sheets woven with titanium wires were rolled tightly around an air stone 12 inches long and zip tied in place. The ends of the cylindrical cathode were attached to the sides of the tank, allowing the electrode to rest in the water column. In Cell 2 and 3 conditions, the titanium wire attached to the cathode was connected across a 330 Ohm resistor to the anode.

A reference electrode was also placed in the water column and attached to the external breadboard in order to log anode and cathode potentials relative to reference in additional to overall cell potential.

Polarization resistance and microsensor profiling data was collected on day 0, 7, 27, 46 and 98. Voltage and current was logged continuously using Arduino Uno's connected through the breadboards of Cell 1, Cell 2, and Cell 3 to a raspberry pi computer which recorded the data collected through a python script. Logging stopped between day 31 and 37 due to a power outage. Voltage and current logging for Cell 1 was stopped on day 14 due to the realization that the Arduino made a connection between the anode and cathode, creating an electric circuit and compromising the open circuit control condition.

The Polarization Resistance test, run with the Potentiostat, sweeps through a range of voltages, measuring current at each voltage. Using Ohm's law, P=IV (where P is power, I is current, and V is voltage), the surface area of the anode, and voltage and current data outputted by the polarization resistance test, power density and current density were attained. These values were used to produce power curves for each cell. A power curve indicates the external resistance at which the cell produces maximum power as well as the value of maximum power it can produce.

Hydrogen sulfide, pH, and dissolved oxygen Unisence microsensors were used to generate depth profiles through the sediment at 100 μm resolution for five time points. On August 9^{th} (day 0), initial profiles were collected for each parameter in each tank before connecting the SMFCs on August 10^{th} (day 1). At each time point, with the exception of the final time point, one profile was collected for each parameter in each tank. The number of profiles collected were limited during the experiment in an effort to reduce the number of holes created by the sensors that allow oxygen to penetrate further into the sediment. For the final time point, three replicate profiles of each parameter were taken for each condition in order to determine variability within the tanks.

Depth profiles of oxygen, pH and hydrogen sulfide were used to investigate the redox reactions taking place in the sediment of each tank. Total sulfide (H₂S+HS−+S²⁻) was calculated from hydrogen sulfide and pH measurements using Equations 1-6, below. Total sulfide was collected to analyze temporal changes and condition based variation in the amount of sulfide produced from anaerobic sulfate reduction in sediment.

$$\begin{matrix} [ {H}_{2} S ] = \frac{[ {S}_{tot}^{- 2} ]}{\{ 1 + \frac{{K}_{1}}{[ {H}_{3} {O}^{+} ]} \}} for pH < \text{?} & ( 1 ) \\ pH = - log [ {H}^{-} ] & ( 2 ) \\ [ {H}_{3} {O}^{+} ] = [ {H}^{-} ] = {10}^{- pH} & ( 3 ) \\ {K}_{1} = \text{?} & ( 4 ) \\ {pK}_{1} = - 98.08 + \frac{5765.4}{T} + 15.04555 * ln ( T ) + ( - 0.157 * ( \text{?} ) ) + 0.0135 * 5 & ( 5 ) \\ [ {H}_{2} S ] \text{?} [ {S}_{tot}^{- 2} ] for pH < 4 \\ \text{?} \text{indicates text missing or illegible when filed} & ( 6 )\end{matrix}$$

The final three replicates of total sulfide profiles for each tank on day 98 were integrated from 0 to 5 cm depth to attain replicates of total sulfide content. Prior to integration, the point of sulfide increase was aligned between replicates within tank conditions but not between conditions. Normal distribution of the dataset containing three replicates of integrated sulfide content for each condition was assessed using a Shapiro-Wilk test of normality in SPSS software at an a-priori of p<0.05. Homoscedasticity for the dataset was assessed using Levene's Test of Equality of Error Variances in SPSS software at an a-priori of p<0.05. A one-way ANOVA was run at an a-priori of p<0.05 to test for a significant difference in final total sulfide content within all four conditions: Cell 1, Cell 2, Cell 3 and Control. A Tukey post hoc test was run to determine which conditions exhibited significant differences in final sulfide content at an a-priori of p<0.05.

Initial total sulfide content for each tank was calculated by integrating the profiles collected on day 0. An average of the three replicates of total sulfide content collected on day 98 was used as final total content for each tank. The change in sulfide content in each tank over the duration of the experiment was calculated by subtracting the initial content from the final content.

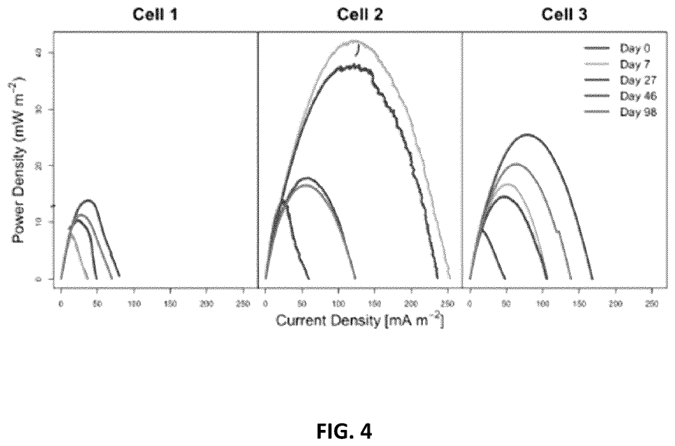

The performance of each microbial fuel cell is shown in FIG. 4, where the peak of each power curve represents the maximum power of the cell at that time point. Over the duration of the experiment, the greatest value of maximum power achieved by Cell 1 was 14 mWm-₂on day 46, by Cell 2 was 42 mWm-₂on day 7 and by Cell 3 was 26 mWm-₂on day 46. Cell 2 reached its greatest value of maximum power 39 days before Cell 1 and Cell 3. In Cell 1 and 2, the value of maximum power increased until the greatest value was reached, then subsequently decreased until the end of the experiment. The same general trend applies to Cell 3, with the exception of a decrease in maximum power from day 7 to day 27. Over the duration of the experiment, potentials for Cell 2 and 3 remained around 500 mV (logging data not shown).

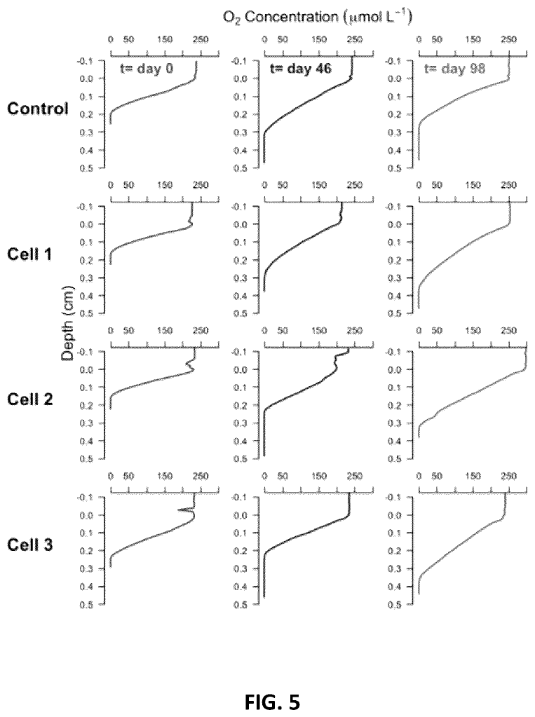

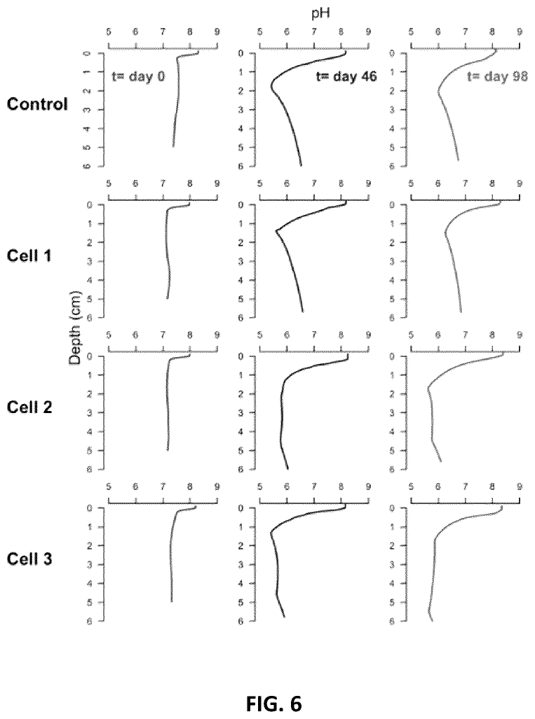

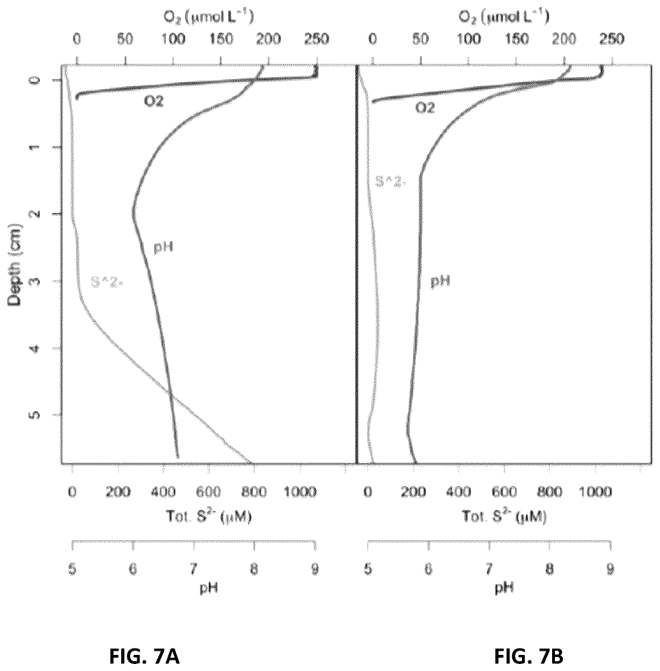

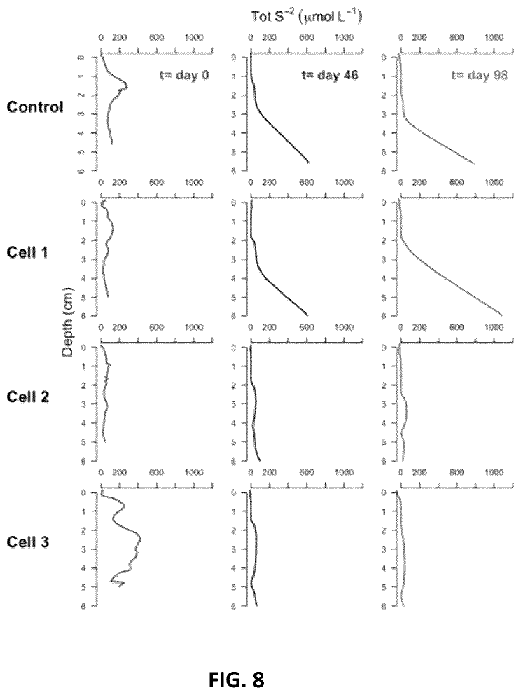

Profiles of oxygen and pH at three time points (Day 0, 46, and 98) for each tank condition are shown in FIG. 5 and FIG. 6, respectively. FIG. 7 shows oxygen, pH and total sulfide profiles taken at the end of the experiment (day 98) for a tank containing a running microbial fuel cell (FIG. 7B) and a control tank (FIG. 7A). Data from the Control and Cell 3 conditions were used for the purpose of comparison. Overall, pH was lower in tanks containing an active SMFC (FIG. 7B) than in control tanks (FIG. 7A). In both active SMFC and control conditions, pH decreased in the top 1-2 cm. In only control profiles (FIG. 7A, FIGS. 5 and 6), pH increased below 2 cm depth. These findings were consistent across all conditions as shown in FIGS. 5 and 6. There was a linear increase in sulfide below 3 cm depth in the control tanks (FIG. 7A) that was not found in tanks containing an active fuel cell (FIG. 7B). This finding was also consistent across all conditions as shown in FIG. 8. The oxygen profiles in FIG. 7 follow the same trend with depth. The oxygenated layer of sediment was slightly shallower in the Control condition (FIG. 7A) than in the Cell 3 condition (FIG. 7B), however this was not characteristic of both control conditions (FIGS. 5 and 6). The oxygen profiles in FIGS. 5 and 6 show that sediments containing Cell 1, 2 and 3 exhibited similar depths of oxygen penetration.

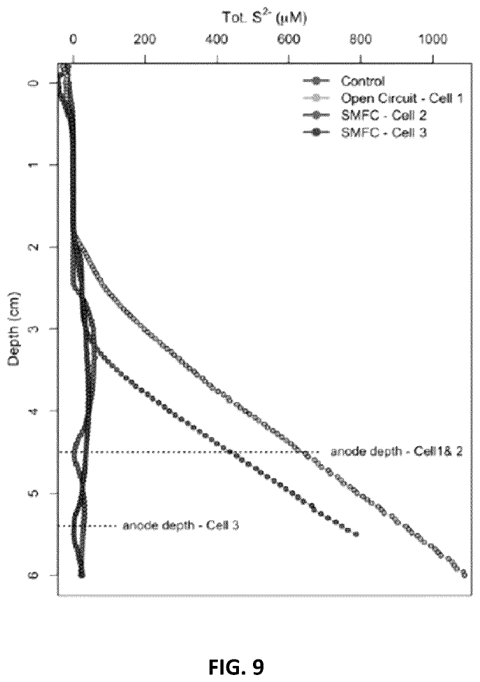

Final sulfide content replicates for all four conditions passed assessments of normalcy (p>0.05, Table 1) and homoscedasticity (p>0.05, Table 1), indicating that they were eligible for further assessment with analysis of variance (ANOVA). The ANOVA indicated a significant difference (F(3,8)=394.2, p<0.05) in final sulfide content between at least two of the conditions. A Tukey test was run to determine which conditions exhibited significant differences. The results of the Tukey test are displayed in Table 1. At the end of the experiment, the total sulfide content in both control tanks (Control and Cell 1) was significantly different (p<0.05) than the total sulfide content in each tank containing an active SMFC (Cell 2 and Cell 3) (Table 3). Final total sulfide profiles (FIG. 8, FIG. 9) show that by the end of the experiment, the amount of sulfide in control sediments was significantly greater than in sediments containing an active fuel cell.

TABLE 2
Shapiro-Wilk Test of normality for the dataset containing final
integrated sulfide replicates for each condition.
Shapiro-Wilk Test of Normality

| Condition | Statistic | df | Significance |
|---|---|---|---|
| Cell 1 | 0.785 | 3 | 0.080 |
| Cell 2 | 0.926 | 3 | 0.475 |
| Cell 3 | 0.864 | 3 | 0.278 |
| Control | 0.998 | 3 | 0.925 |

TABLE 3
Levene's Test of Equality of Error Variances for the dataset
containing final integrated sulfide replicates for each condition.
Levene's Test of Equality of Error Variances

| | Levene Statistic | df1 | df2 | Significance |
|---|---|---|---|---|
| Based on Mean | 1.017 | 3 | 8 | 0.434 |
| Based on Median | 0.468 | 3 | 8 | 0.713 |
| Based on Median and | 0.468 | 3 | 6 | 0.715 |
| adjusted df | | | | |
| Based on trimmed mean | 0.975 | 3 | 8 | 0.451 |

TABLE 4
The results of a Tukey test run at an a-priori of p < 0.05 with a 95%
confidence interval.

| Conditions | p > 0.05 or p < 0.05 |
|---|---|
| Cell 3-Cell 2 | p > 0.05 |
| Control-Cell 2 | p < 0.05 |
| Cell 1-Cell 2 | p < 0.05 |
| Control-Cell 3 | p < 0.05 |
| Cell 1-Cell 3 | p < 0.05 |
| Cell 1-Control | p < 0.05 |

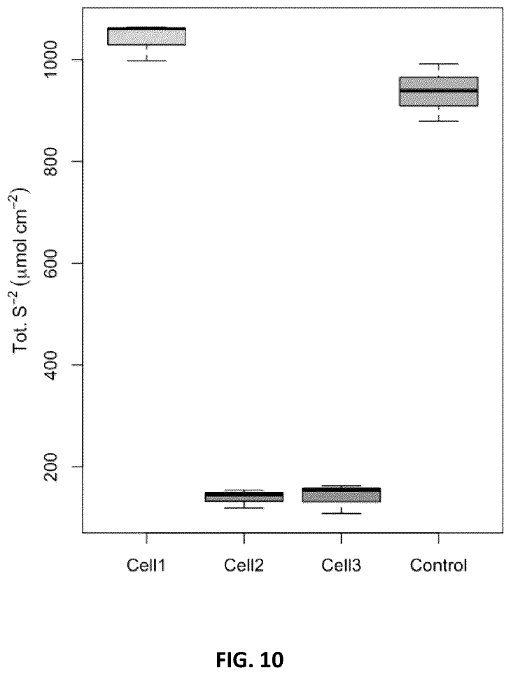

The Tukey test found 3 homogenous subsets among the four conditions as shown in FIG. 10, where only two conditions exhibited no significant difference between one another (Cell 2 and 3) and were therefore statistically similar. FIG. 10 also shows the variability in replicates of final total sulfide content within each condition, with the mean value indicated by a thick black line.

Table 5, below, shows that the tanks containing active SMFCs (Cell 2 and 3) exhibited a net reduction in sulfide content and control tanks (Cell 1 and Control) exhibited a net accumulation of sulfide. Table 4 and FIG. 10 indicate there was a significant difference between the final sulfide content in the two types of controls, Control (with no fuel cell materials) and Cell 1 (with disconnected fuel cell components) and no significant difference between the two active fuel cell conditions, Cell 2 and 3.

TABLE 5
Initial total sulfide content (μmol cm-2), final total sulfide content
(μmol cm-2), and change in total sulfide content (μmol cm-2) over the
duration of the experiment for each condition.

| | Initial Tot. S²⁻ | Final Tot. S²⁻ | Change in Tot. S²⁻ |
|---|---|---|---|
| | Content | Content | Content |
| Tank | (μmol cm⁻²) | (μmol cm⁻²) | (μmol cm⁻²) |
| Cell 1 | 316.262 | 1040.646 | 724.384 |
| Cell 2 | 233.533 | 139.458 | −94.075 |
| Cell 3 | 1270.056 | 141.667 | −1128.389 |
| Control | 538.421 | 936.606 | 398.185 |

Discussion

Power curves for Cell 2 and 3 shown in FIG. 4 demonstrate the functionality of the active microbial fuel cells. The maximum power output attained is similar to that achieved in previous sediment microbial fuel cell experiments. The potential oxidation of sulfide to elemental sulfur at the anode could explain the reduction of maximum power part-way through the experiment in Cell 2 and 3 (FIG. 4). Previous studies have suggested that the deposition of elemental sulfur can deactivate the anode surface, limiting electron transfer and power generation. Current density can be limited by a number of other processes including, but not limited to: reduced availability of substrate, microbe inhibition due to acidification of the biofilm at the anode and electron transport from bacteria to the anode through the biofilm. Understanding transport processes in microbial electrochemical technologies remains an area of active research that will contribute to optimizing SMFC design.

The primary decomposition reactions that took place in the sediment of each tank are inferred from the profiles in FIGS. 7A and 7B. The consumption of oxygen in respiration within the top few millimeters of sediment was apparent in tanks with active SMFCs (FIG. 7B) and control tanks (FIG. 7A). As oxygen was consumed, pH decreased in both profiles in response to the production of carbon dioxide (FIGS. 5-7). The profiles in FIGS. 7A and B show that pH was overall lower in the sediment of tanks containing active SMFCs compared to those without an active cell. Once reduced to <6, pH remained low in tanks containing an active fuel cell (FIGS. 5-7). In contrast, pH remained >6 and increased below 2 cm depth in control tanks (FIG. 7A, FIGS. 5, 6). This difference could be explained by the presence of hydrogen ions released in oxidation reactions at the anode.

Final sulfide content was significantly greater in control conditions (Cell 1 and Control) than in tanks containing active SMFCs (Cell 2 and Cell 3) (Table 4). Tanks containing active SMFCs exhibited a net reduction in sulfide over the course of the experiment and control tanks exhibited a net accumulation (Table 5). These findings support the hypothesis that oxidation reactions at the anode can prevent the accumulation of sulfide in sediments. This presents a new application of microbial fuel cells that can positively contribute to maintaining the health of benthic marine environments.

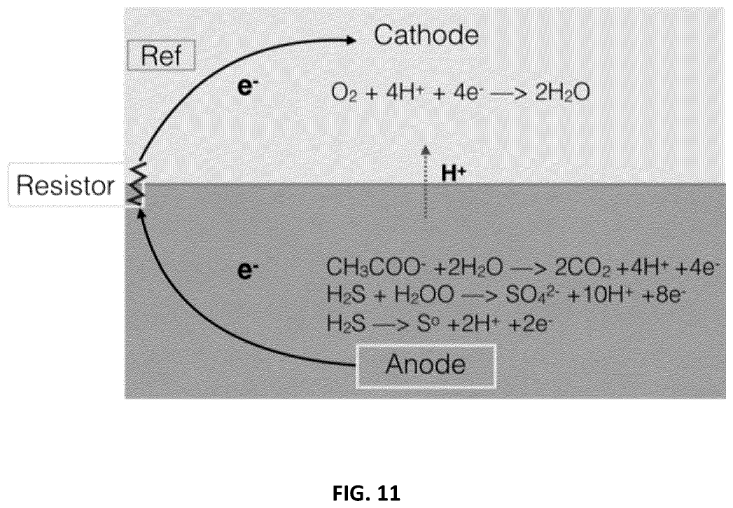

The net reduction of sulfide in SMFC conditions could be explained by reactions at the anode or a combination of anodic reactions and sulfide removal processes. The probable reactions taking place at the anode in sediments containing active SMFCs include microbially mediated electrochemical oxidation of organic matter and/or oxidation of sulfide to sulfate or elemental sulfur, the latter potentially coupled to sulfate reduction. These oxidation reactions are the mechanisms by which SMFCs mitigate sulfide accumulation. Sulfide in sediments has multiple sinks. It can be oxidized to sulfate, sulfur, polysulfide or thiosulfate in oxygenated regions of sediment or it can react with iron to form iron sulfides._{38, 39} In the presence of an anode, sulfide can also be electrochemically oxidized in anoxic regions of sediment. Due to the presence of multiple sinks with the potential to explain the removal of sulfide in active SMFC conditions, any of the three anodic reactions stated in FIG. 11 could be the primary source of electrons in Cell 2 and 3. Determining the primary reaction supplying electrons to the anode is an active area of research that this study does not attempt to contribute to. Previous benthic microbial fuel cell experiments have found sulfur accumulated on the anode, providing evidence to support the role of sulfide oxidation to elemental sulfur in SMFCs._{35, 40, 41} Therefore, elemental sulfur and sulfate measurements should be incorporated into future studies to improve understanding of the reactions occurring at the anode and the processes responsible for sulfide removal.

Cell 2 and 3 were determined to belong to one homogenous subset as shown in FIG. 10. This is to be expected because these two tanks operated as replicates for the majority of the experiment (day 14 to 98). A significant difference in final sulfide content was found between the two control conditions (Table 4). Visible differences in time series sulfide profiles (FIG. 8) between the two conditions may explain why. The sulfide profile from the Cell 1 condition tank on day 98 shows a linear increase in sulfide below approximately 2 cm depth (FIG. 8, FIG. 9). In contrast, sulfide in the Control tank on day 98 began to increase at the same approximate depth but leveled off for ˜1 cm before exhibiting the linear increase shown in the Cell 1 profile (FIG. 8, FIG. 9). The same trend seen in the final Control sulfide profile is shown in both the Cell 1 and Control profiles from day 46 (FIG. 8). A possible explanation for the leveling of sulfide as it begins to increase in the anoxic layer is the presence of iron. As stated previously, sulfide in marine sediments could accumulate, diffuse to oxygenated regions of sediment where it is oxidized, or react with iron (primarily iron oxides) to form iron sulfides._{35, 39} The formation of iron sulfides shown in the following equation, could explain reduced sulfide concentrations in the top portion of the anoxic layer in Control and Cell 1 profiles from day 46 (FIG. 8) and the Control profile from day 98 (FIG. 8, FIG. 9):

S⁻+Fe²⁺→FeS

After iron oxides, which react rapidly with sulfide, are consumed, the remaining iron minerals react with sulfide at a slowed rate, allowing it to accumulate. In the Cell 1 condition, the formation of iron sulfides could have potentially been limited by reactive iron oxides by the end of the experiment, accounting for the accumulation of sulfide in the top portion of the anoxic layer between day 46 and 98. This reasoning could explain the significant difference in final sulfide content between the control conditions as shown in Table 4.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A microbial electrochemical cell for remediating aquaculture sediment below an aquaculture cage, the microbial electrochemical cell comprising:
a) an anode electrode configured to be disposed in an anoxic or suboxic environment below a surface of water, the anode electrode oxidizing hydrogen sulfide in the water upon receiving electrons from anaerobic decomposition of organic matter or other reduced compounds produced by microbes in the sediment below the surface of the water;
b) a cathode electrode configured to be spaced apart from the anode and disposed in an environment at a higher electrochemical potential than the anoxic environment, the cathode electrode electrically connected to the anode electrode to receive the electrons from the anode electrode;
c) a reference electrode configured to be disposed in the environment at the higher electrochemical potential than the anoxic environment, the reference electrode having a stable electrode potential; and
d) a potentiostat electrically configured to be connected to each of the anode electrode, the cathode electrode and the reference electrode, the potentiostat configured to receive the electrons from the anode electrode and control distribution of the electrons to the cathode electrode based on a potential difference between the anode electrode and the reference electrode.

2. The microbial electrochemical cell of claim 1 further comprising an external power source electrically connected to the potentiostat, an external power source providing energy to the potentiostat for maintaining the potential difference between the anode electrode and the reference electrode.

3. The microbial electrochemical cell of claim 1, wherein the anode electrode is disposed in water at a lower electrochemical potential than the cathode.

4. The microbial electrochemical cell of claim 3, wherein the anode electrode is disposed on top of the sediment below the surface of the water.

5. The microbial electrochemical cell of claim 4, wherein the anode electrode has an open configuration to provide for organisms to burrow into the sediment through apertures in the anode electrode.

6. The microbial electrochemical cell of claim 1, wherein the anode electrode is disposed below a surface of the sediment.

7. The microbial electrochemical cell of claim 1, wherein the anode electrode is a carbon fibre net.

8. The microbial electrochemical cell of claim 1, wherein the anode electrode has a square or circular shape.

9. The microbial electrochemical cell of claim 1, wherein the anode electrode has a three-dimensional shape.

10. The microbial electrochemical cell of claim 1, wherein the anode electrode has a fixed electric potential as set by the potentiastat.

11. The microbial electrochemical cell of claim 1, wherein the reference electrode is disposed in the aerobic water.

12. The microbial electrochemical cell of claim 1, wherein the potentiostat is electrically coupled to each of the anode electrode, the cathode electrode and the reference electrode by an electrically conductive connector.

13. The microbial electrochemical cell of claim 12, wherein the electrically conductive connector is a wire and the wire is woven through or fastened to a portion of the anode electrode.

14. The microbial electrochemical cell of claim 1, wherein the microbial electrochemical cell is part of a filtration and water purification apparatus of a land-based aquaculture tank.

15. A method of remediating aquaculture sediment below an aquaculture cage, the method comprising:
a) disposing an anode electrode in an anoxic or suboxic environment below a surface of water, the anode electrode oxidizing hydrogen sulfide in the water upon receiving electrons from anaerobic decomposition of organic matter or other reduced compounds produced by microbes in the sediment below the surface of the water;
b) disposing a cathode electrode spaced apart from the anode in an aerobic environment below the surface of water, the cathode electrode electrically connected to the anode electrode to receive the electrons from the anode electrode;
c) disposing a reference electrode in the anoxic environment below the surface of the water, the reference electrode having a stable electrode potential;
d) electrically connecting a potentiostat to each of the anode electrode, the cathode electrode and the reference electrode, the potentiostat configured to receive the electrons from the anode electrode; and
e) controlling distribution of the electrons to the cathode electrode based on a potential difference between the anode electrode and the reference electrode.

16. The method of claim 15, wherein the aquaculture sediment is below a freshwater or ocean-based finfish aquaculture cage.

17. The method of claim 15, wherein the aquaculture sediment is below a shellfish aquaculture cage.

16. The method of claim 15, wherein the aquaculture sediment is below a freshwater or ocean-based finfish aquaculture cage.

17. The method of claim 15, wherein the aquaculture sediment is below a shellfish aquaculture cage.

18. The method of claim 15 to 17, further comprising fixing an electric potential of the anode electrode by the potentiostat.
